(19) United States
(12) Patent Application Publication
(10) Pub. No.: US 2011/0198152 A1
(43) Pub. Date: Aug. 18, 2011

(54) FALL ARREST ASSEMBLY

(76) Inventor: Leigh Dowie, Western Australia (AU)

(21) Appl. No.: 12/676,674

(22) PCT Filed: Sep. 5, 2008
(86) PCT No.: PCT/AU08/01329

§ 371 Date: Nov. 24, 2010

(30) Foreign Application Priority Data
Sep. 5, 2007 (AU) 2007904787

(51) Int. Cl. A62B 35/00

(52) U.S. Cl. 182/3

(57) ABSTRACT

A fall arrest assembly (51) for arresting the fall of an operator (23) working at an elevated height, the assembly (51) comprises a frame (3) which is adapted to be secured to a structure, such as a trailer (2), and is moveable between a collapsed condition and an operating condition. The assembly (51) also incorporates a control means (18) to move the frame between the two conditions and a fall arrest device (53). The fall arrest device (53) is adapted to cooperate with the frame (3) when in the operating condition, whereby the fall arrest device (53) locks when the operator (23) falls from the elevated height to prevent the operator falling further. Should the operator (23) experience a fall the frame (3) supports the operator until the operator can be released.

### PRIORITY STATEMENT AND CROSS-REFERENCE TO RELATED APPLICATIONS

This application claims the benefit under 35 U.S.C. §365(b) of PCT/AU2008/001329 to Leigh DOWIE, filed Sep. 5, 2008 and entitled “FALL ARREST ASSEMBLY, now pending, which in turn claims priority to co-pending Australian patent application number 2007904787 by the same inventor, filed Sep. 5, 2007. The entirety of the contents of each application is hereby incorporated by reference herein. The present application is also related to international application number PCT/AU2005/000656 to Leigh DOWIE, filed May 9, 2005, and entitled “SAFETY APPARATUS”, now expired, the entire contents of which is hereby incorporated by reference herein.

### FIELD

The example embodiments in general relate to safety devices and more specifically to a fall arrest assembly that is used to ensure the safety of people working at elevated heights, particularly on vehicles such as trucks, trailers and rail cars.

### RELATED ART

Falling from height remains one of the leading causes of death in the workplace and as such, is receiving more and more attention in recent times. The first priority in such situations is to remove the hazard all together. Unfortunately, it is not always possible to do so and in these instances, a fall arrest assembly should be adopted.

One particular industry that has significant height safety concerns is the transport industry. In this industry, many instances arise where operators must climb up onto their vehicle for either maintenance issues or tasks such as securing and protecting their cargo. As these tasks are often unavoidable, recent efforts in reducing fall risk have been directed towards providing fall protection systems in order to ensure the safety of the operators.

A system that addresses some of the safety concerns requires the provision of bays, having overhead fall arrest assemblies, and in to which the vehicle can be parked. This has achieved limited success as that operators are often required to inspect the top of their cargo in remote locations. As such, the need for these safety systems to be integrated into the vehicle itself has become evident.

Problems associated with incorporating these systems into existing vehicles have included reduced operational functionality of the vehicle once the system has been installed, total re-engineering of the vehicle required in order to provide a satisfactory structure for the system, and failure to adequately ensure the safety of the operator.

The preceding discussion of the background to the invention is intended only to facilitate an understanding of the present invention. It should be appreciated that the discussion is not an acknowledgment or admission that any of the material referred to was part of the common general knowledge as at the priority date of the application.

### SUMMARY

An example embodiment of the present invention is directed to a fall arrest assembly for arresting the fall of an operator, or object, working at an elevated height. The assembly Includes a frame which is adapted to be secured to a structure and is moveable between a collapsed condition and an operating condition; a control means to move the frame between conditions; and a fall arrest device to which the operator is to be connected, the fall arrest device being adapted to cooperate with the frame when in the operating condition, whereby the operator connects to the fall arrest device prior to moving to the elevated height. The fall arrest device locks when the operator falls from the elevated height to prevent the operator falling further, the frame supporting the operator until the operator can be released.

In one example, when in the collapsed condition the frame does not interfere with the structure and its intended operation. In one example, when in the collapsed condition the fall arrest assembly does not interfere with the structure and its intended operation.

It is to be understood that the elevated height may be located below the structure to which the fall arrest assembly is secured.

The frame may have at least two frame members which may be secured to the structure a distance apart whereby the operator operates therebetween. The frame may also comprise a reinforcement member extending between the two ends of the frame members remote from the ends secured to the structure. Preferably the reinforcement member is located adjacent or below a surface of the structure when the fall arrest assembly is in the collapsed condition. Each frame member may be movable between a collapsed position and an operating position.

In an example, each frame member is of hollow construction. Further, each frame member may be reinforced to resist bending moments and forces which may be experienced by the frame.

In one example, each frame member comprises two elongate elements pivotally connected. In another example, each frame member is telescopic in nature.

In a further example, each frame member comprises an elongate element wherein the elongate element is adapted to be pivotally connected to the structure such that the frame member can move between positions.

The control means may be manually or automatically operated. In one example the control means moves each frame member between its positions. The control means may include hydraulically operated systems, electro-mechanical type systems or purely mechanical systems that require manual effort by the user to operate, such as screw jacks etc.

In an example, the control means may be in the form of a hydraulic assembly between each elongate element of each frame member to assist in moving the frame member between positions. The hydraulic assembly may incorporate one or more hydraulic rams that are either directly connected to each frame member or connected via a series of linkages or the like, so as to provide the range of motion required to move each frame member between positions.

The incorporation of an electro-mechanical control means may include an electric motor to provide the mechanical effort. This may then be coupled to a gearbox or the like that transfers the output from the motor into a useable range of motion for the frame. Similarly, a purely mechanical system may create a mechanical advantage to transform the physical effort of the operator into a useful form for the deployment of the frame.

The fall arrest device may comprise at least one self retracting lanyard system. Preferably there are two self retracting lanyard systems. Each self retracting lanyard system may comprise a retractable cable adapted to be secured to the operator. This may be via a harness worn by the operator.

Another example embodiment is directed to a fall arrest device as described in International application WO 2005/108713 by the inventor. The fall arrest device includes a first receiving means and a second receiving means each adapted to be releasably secured to a structure, a locking device operably movable between a released condition whereby the first receiving means and second receiving means can move independently of each other, and a locked condition whereby each receiving means is locked relative to each other, and at least one cable having a portion adapted to receive and support a securing device attached to an operator. When the apparatus supports a fallen operator the locking device is maintained in a locked condition, locking the first receiving means relative to the second receiving means, preventing the length of the at least one cable between the first receiving means spool and second receiving means spool from increasing, therefore preventing the operator from falling any further.

In an example, the at least one cable extends from the first receiving means to the second receiving means, via a second support assembly, such as the frame.

The fall arrest device may be secured to the structure. In an example the fall arrest device is secured at the base of one of the frame members. Further, each frame member may have guide means to guide the cable of each self retracting lanyard system therealong. The guide means may comprise a plurality of guides and pulleys.

Each cable may be guided into respective frame members via a series of guides or pulleys. The cable may then exit the top of the frame member via another series of pulleys or guides. This provides a safe and secure passage to the top of the frame member for the cable where it can provide the overhead support to the operator.

Where the fall arrest device is in the form of a single self retracting lanyard system the cable may extend through one of the frame members, through a connection means adapted to be secured to the operator's harness, through the other frame member via the top before being secured to the structure.

Where the fall arrest assembly is in the form of two self retracting lanyard systems each lanyard may extend through respective frame members and connect at a point between the frame members where the operator may also be secured.

In other examples the fall arrest device may be in the form of a beam/trolley type system or static line type system. The specific selection of which would occur based upon the needs of the application.

The structure may be in the form of a flat bed trailer of a prime mover/semitrailer. In this application the frame members may be located on the perimeter of the trailer so that the frame does not encroach into the useable storage space of the trailer, and when in the collapsed condition the frame can be stowed within the allowable height of the vehicle. When erected, the frame would provide the overhead support of the fall arrest assembly.

Another example embodiment is directed to a fall arrest assembly for arresting the fall of an operator, or object, working at an elevated height, the assembly including a frame which is adapted to be secured to a structure and is moveable between a collapsed condition and an operating condition; and a fall arrest device to which the operator is to be connected, the fall arrest device being adapted to cooperate with the frame when in the operating condition, whereby the operator connects to the fall arrest device prior to moving to the elevated height. The fall arrest device locks when the operator falls from the elevated height to prevent the operator falling further, the frame supporting the operator until the operator can be released.

Another example embodiment is directed to a fall arrest assembly for arresting the fall of an operator working at an elevated height, the assembly including a frame which is adapted to be secured to a structure and is moveable between a collapsed condition and an operating condition; a control means to move the frame between conditions; and a fall arrest device to which the operator is be connected, the fall arrest device being adapted to cooperate with the frame when in the operating condition, whereby the operator connects to the fall arrest device at ground level prior to moving to the elevated height. The fall arrest device locks when the operator falls from the elevated height to prevent the operator falling further, the frame supporting the operator until the operator can be released.

Another example embodiment is directed to a fall arrest assembly for arresting the fall of an operator working at an elevated height, the operator wearing a harness. The assembly includes a frame which is adapted to be secured to a structure and is moveable between a collapsed condition and an operating condition; a control means to move the frame between conditions; and a fall arrest device to which the harness is to be connected, the fall arrest device being adapted to cooperate with the frame when in the operating condition, whereby the harness is connected to the fall arrest device prior to moving to the elevated height. The fall arrest device locks when the operator falls from the elevated height to prevent the operator falling further, the frame supporting the operator until the operator can be released.

Another example embodiment is directed to a fall arrest assembly for arresting the fall of an operator, or object, working at an elevated height. The assembly includes a frame which is adapted to be secured to a structure and is moveable between a collapsed condition and an operating condition; a control means to move the frame between conditions; and a fall arrest device which is adapted to cooperate with the frame when in the operating condition. The fall arrest device locks when the operator falls from the elevated height to prevent the operator falling further, the frame supporting the operator until the operator can be released.

Another example embodiment is directed to a fall arrest assembly for arresting the fall of an operator, or object, working at an elevated height. The assembly includes a frame which is adapted to be secured to a structure and is moveable between a collapsed condition and an operating condition; and a fall arrest device which is adapted to cooperate with the frame when in the operating condition. The fall arrest device locks when the operator falls from the elevated height to prevent the operator falling further, the frame supporting the operator until the operator can be released.

### BRIEF DESCRIPTION OF THE DRAWINGS

Example embodiments will become more fully understood from the detailed description given herein below and the accompanying drawing, wherein like elements are represented by like reference numerals, which are given by way of illustration only and thus are not limitative of the example embodiments herein.

FIG. 1 is a schematic of the fall arrest assembly in an operating condition according to an example embodiment of the present invention.

FIG. 2 is similar to FIG. 1 but having the fall arrest assembly in a contracted condition.

FIG. 3 is a view of a fall arrest device according to an embodiment of the invention secured to the structure.

FIG. 4 is a frame member of the fall arrest assembly as shown in FIG. 1.

FIG. 5 is a representation of the example embodiment as shown in FIGS. 1 to 4 when in use by an operator.

FIG. 6 is a view of a fall arrest device according to another example embodiment of the present invention.

FIG. 7 is a cross sectional view of a first support assembly of the fall arrest device shown in FIG. 6.

### DETAILED DESCRIPTION

As detailed hereafter, the example embodiments describe an improved fall arrest assembly which can be secured to a structure whereby an operator can operate safely at an elevated height.

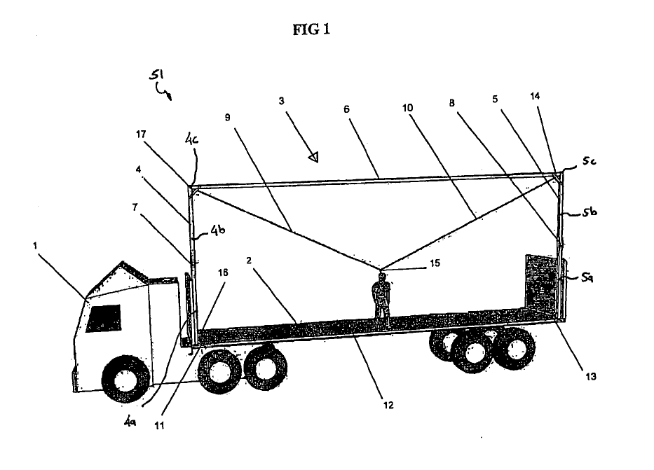

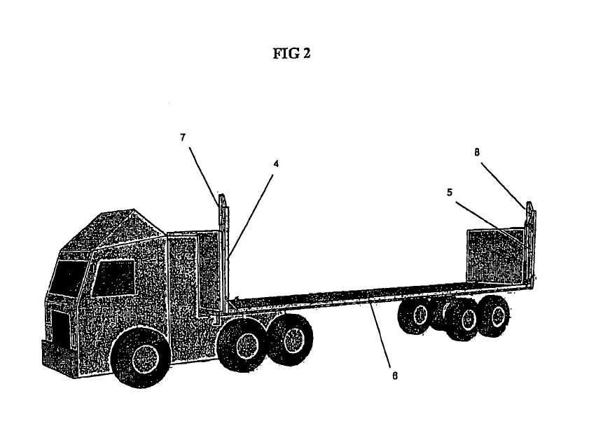

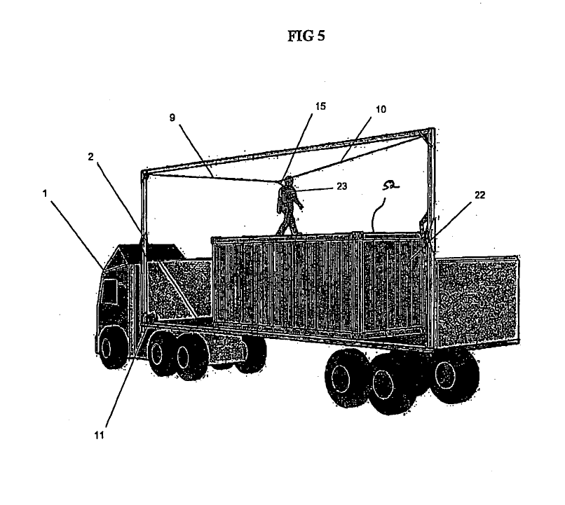

Referring to the FIGS. 1 to 5, the invention according to an example embodiment is in the form of a fall arrest assembly 51 secured to a structure which is in the form of a trailer 2 of a truck 1. The fall arrest assembly 51 is moveable between an operable condition whereby an operator 23 may be secured via a harness 15 to the fall arrest assembly 51 to be supported thereby, as shown in FIGS. 1 and 5, and a collapsed condition in which the fall arrest assembly 51 does not substantially interfere with the operation of the truck, as best sown in FIG. 2.

The fall arrest assembly 51 provides the operator 23 with a means to safely operate at and elevated height 52, which in this embodiment is provided by cargo 22, see FIG. 5. In other applications of the fall arrest assembly 51, and embodiments, the elevated height is any height from which a fall may result in an injury or fatality and includes those located below the structure to which the fall arrest assembly is secured.

The fall arrest assembly 51 comprises two frame members 4, 5 which are secured to a side 12 of the trailer 2. Each frame member 4, 5 is movable between an operating position and a collapsed position, enabling the fall arrest assembly 51 to move between its two conditions. Each frame member 4, 5 comprises a first elongate element 4a, 5a pivotally connected to a second elongate element 4b, 5b by knee joints 7, 8.

Each frame member 4, 5 is hollow in construction and has guide means 16, 13 for reasons which will be described below. Each guide means incorporates a pulley 14, 17 adjacent the end of each frame member 4, 5.

The frame 3 also comprises a reinforcing member 6 which extends between each frame member 4, 5 at ends 4c, 5c remote from the end the frame members 4, 5 are secured to the trailer 2. The reinforcing member 6 strengthens the frame 3 so as to accommodate forces the fall arrest assembly 51 is exposed should the operator 23 fall from the elevated height 52. The reinforced member 6 acts as a compression member so as to prevent the frame members 4, 5 having to act as cantilevered sections in the direction of the trailer 2.

The knee joints 7, 8 are located mid way along each frame member 4, 5 such that when the frame is in a collapsed condition, as shown in FIG. 2, the reinforced member 6 is adjacent the side 12 of the trailer 2. In this position the reinforced member 6 is protected from damage during the loading and unloading operations of the trailer.

Dependent upon the exact application in which the fall arrest assembly 51 is being used, the final location of the reinforcing member 6 could either be above or below the top surface of the trailer 2. In the contracted condition, the overall height of each frame member 4, 5 is within the permissible height of the vehicle so that it can operate in full compliance with the relevant transport codes.

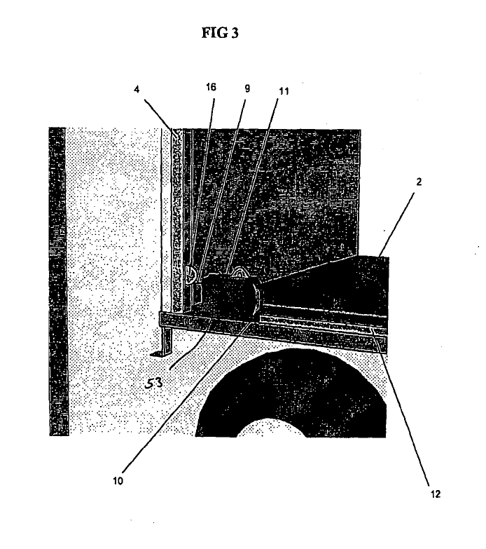

The fall arrest assembly 51 also comprises a fall arrest device 53. The fall arrest device 53 is secured to the operator 23 via a harness 15 and locks should the operator 23 fall from the elevated height 52. The fall arrest device 53 in the present embodiment is in the form of a double self retracting lanyard system 11 secured to the side 12 of the trailer 2, as best shown in FIG. 3.

The lanyard system 11 has a first cable 9 which is guided through the frame member 4 by guide means 16. The cable 9 extends through the top of the frame member 4 and passes over pulley 17.

The lanyard system 11 also has a second cable 10. This extends along the side of the trailer, and is guided through the frame member 5 by guide means 13. The cable 10 extends through the top of the frame member 5 and passes over pulley 14. The end of first cable 9 and second cable 10 are secured together to provide a point at which the harness 15 of the operator 23 may be connected.

The fall arrest assembly 51 also comprises control means 18 to move the frame 3 between the operable and contracted conditions. In the present embodiment the control means 18 is in the form of a hydraulically assisted assembly secured to each frame member 4, 5.

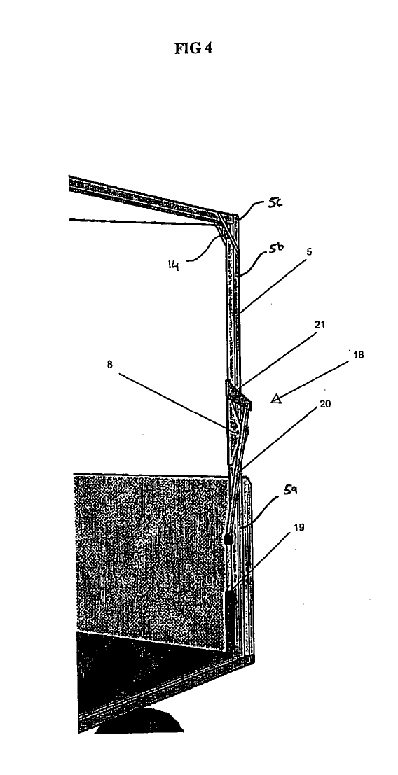

Considering frame member 5 and referring to FIG. 4 the control means 18 comprises a hydraulic ram 19 having one end secured to the first elongate element 5a of the frame member 5 and the other end connected to a pushrod 20. The pushrod 20 is then connected to the second elongate element 5b of the frame member 5 via a connection bracket 21. When the hydraulic ram 19 is extended, the second elongate element 5b of the frame member 5 will rotate about the knee joint 8, until a near vertical state is reached. Similarly, when the hydraulic ram compresses or retracts, the second elongate element 5b of the frame member 5 will fold back down to its contracted position.

In operation the operator 23 connects their harness 15 to the first cable 9 and second cable 10 before climbing up on the trailer 2 and subsequently the elevated height 52 of the cargo 22. Hence the operator is able to be secured to the fall arrest device before moving to a location in which he/she may fall. As would be apparent to a person skilled in the art, the trailer 2 also presents an elevated height. As the operator 23 connects to the fall arrest assembly 51 prior to climbing on the trailer 2, the fall arrest assembly 51 will also arrest the fall of the operator 23 from the elevated height of the trailer 2.

Once connected to the fall arrest assembly 51, the operator 23 is free to move anywhere on top of either the trailer 2 or the cargo 22. When the operator 23 moves toward the truck 1, the first cable 9 will retract and the second cable 10 will extend. If the operator 23 moves away from the truck, the first cable 9 will extend and the second cable 10 will retract. When the operator 23 ascends or climbs vertically upward, both cables 9, 10 will retract. If the operator 23 descends or climbs vertically downward, both cables 9, 10 will extend. If the operator 23 descends too quickly due to a fall or the like, the fall arrest device 11 will lock the cables 9, 10 from extending and prevent any further descent or fall.

In another embodiment not shown, the fall arrest device 53 is in the form of a single self retracting lanyard system 111 having a single cable 9. In this embodiment the route for the cable 9 would differ slightly. One possible route would be to locate the single self retracting lanyard system 111 in a similar location to that depicted by the double self retracting lanyard system 11 of the above first embodiment. The cable 9 would again be directed into the internal cavity of the frame member 4 and exit the approximate upper extremity via the pulley 17. The cable 9 would then pass through a sliding connection on the harness 15 before travelling across to the pulley 14 at the upper extremity of the frame member 5. The cable 9 would then be directed into the internal cavity of the frame member 5 via the pulley 14. The cable 9 would then be anchored near the base of the frame member 5.

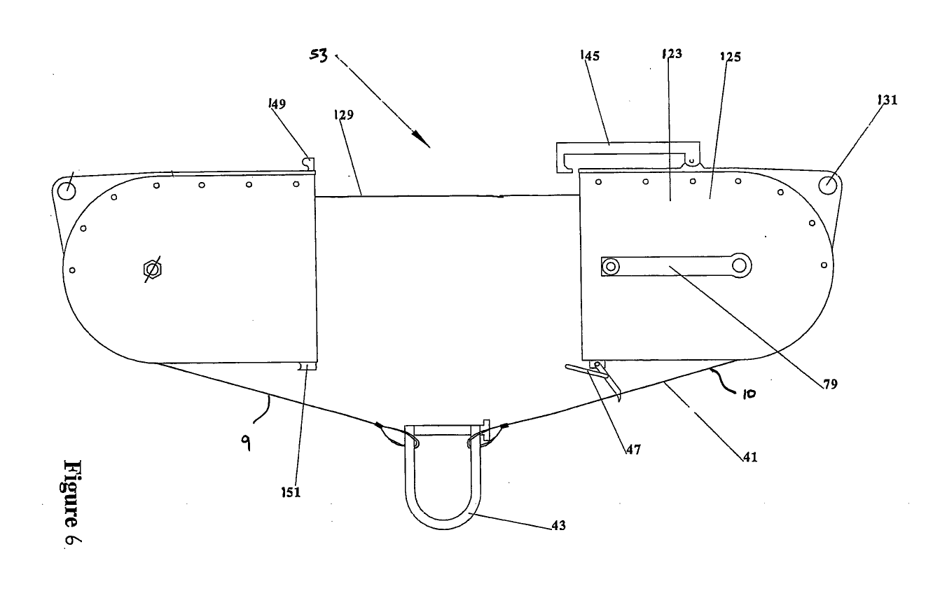

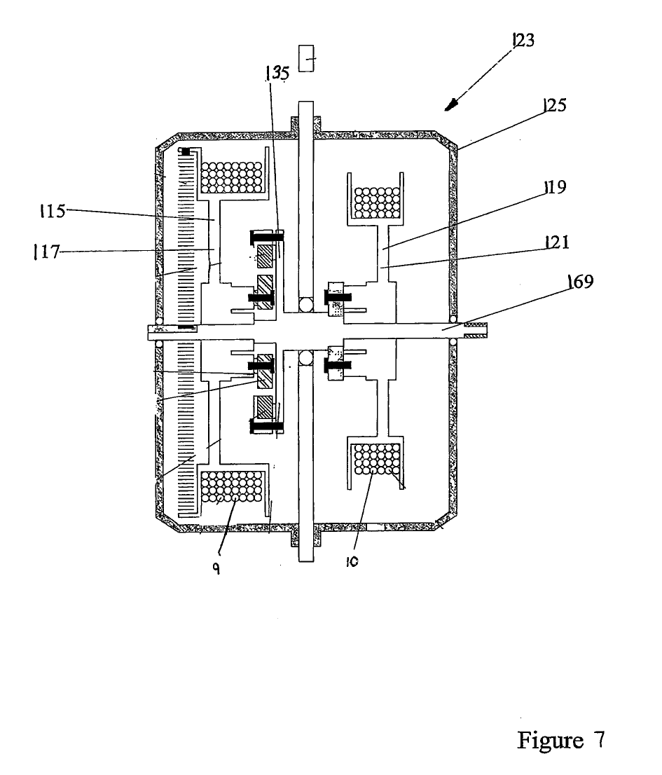

FIGS. 6 and 7 shows another embodiment of the fall arrest device 53. The fall arrest device 53 comprises a first receiving means 115 in the form of a first spool 117 and a second receiving means 119 in the form of a second spool 121. The first spool 117 and second spool 121 are rotatably and coaxially mounted in a first support structure 123 which is in the form of a first housing 125. The first spool 117 is rotatably mounted on a shaft 169 which is rotatably mounted in the first housing 125. The second spool 121 is fixed to the shaft 169.

The fall arrest device 53 comprises a locking device 135 operably movable between a released condition whereby the first spool 117 and second spool 121 can move independently of each other, and a locked condition whereby each spool is partially locked relative to each other.

The fall arrest device 53 also comprises two cables 9, 10 extending from the first spool 117 to the second spool 121. The first cable 9 is retractably received upon the first spool 117 and a second cable 10 is retractably received upon the second spool 121. The first cable 9 and second cable 10 are releasably connected by the shackle 143. The shackle 143 is adapted to receive and support harness 15 attached to the operator 23.

The first spool 117 and second spool 121 are biased in a direction such that each spool 117, 121 places a retractive force on each cable 9, 10. This will ensure that any slack which may develop in the cables 9, 10 will be automatically retracted upon the first spool 117 and/or second spool 121, maintaining the cables 9, 10 in a taut condition.

In FIG. 6 the fall arrest device 53 is not connected to any structure. However, when secured to a structure, such as the trailer 2, the first cable 9 is guided through the frame member 4 by guide means 16. The cable 9 extends through the top of the frame member 4 and passes over pulley 17. Similarly the second cable 10 extends, and is guided through the frame member 5 by guide means 13 after passing along the side of the trailer 2. The cable 10 extends through the top of the frame member 5 and passes over pulley 14. The end of first cable 9 and second cable 10 are then secured together at the shackle 143.

The example embodiments described heretofore may overcome one or more of the problems associated with the prior art by providing a fall arrest assembly that can be easily incorporated into most structures, such as a vehicle, without appreciably reducing the functionality of the structure. The assembly also may provide a solution that minimises the forces transferred into the structure itself, so that total re-engineering of the structure is not required. In addition to this, the assembly may also offer unprecedented levels of operator freedom and safety. The assembly can be easily and rapidly erected so as to provide an overhead fall arrest assembly that is capable of utilizing various types of fall arrest devices. When in the contracted condition, the frame has minimal impact upon the usability of the structure.

Modifications and variations such as would be apparent to the skilled addressee are considered to fall within the scope of the present invention.

Throughout the specification, unless the context requires otherwise, the word “comprise” or variations such as “comprises” or “comprising”, will be understood to imply the inclusion of a stated integer or group of integers but not the exclusion of any other integer or group of integers.

1. A fall arrest assembly for arresting the fall of an operator working at an elevated height, the assembly comprising:
a frame which is adapted to be secured to a structure and is moveable between a collapsed condition and an operating condition;
a control means to move the frame between conditions; and
a fall arrest device to which the operator is to be connected, the fall arrest device being adapted to cooperate with the frame when in the operating condition, whereby the operator connects to the fall arrest device prior to moving to the elevated height;
wherein the fall arrest device locks when the operator falls from the elevated height to prevent the operator falling further, the frame supporting the operator until the operator can be released.

2. The fall arrest assembly according to claim 1 which when in the collapsed condition the frame does not interfere with the structure and its intended operation.

3. The fall arrest assembly according to claim 1 wherein the frame has at least two frame members secured to the structure a distance apart between which the operator is secured when the frame is in the operable condition.

4. The fall arrest assembly according to claim 3 wherein the frame also comprises a reinforcement member extending between the two frame members at the end remote from the end secured to the structure.

5. The fall arrest assembly according to claim 4 wherein the reinforcement member is located adjacent or below a surface of the structure when the frame is in the collapsed condition.

6. The fall arrest assembly according to claim 3 wherein each frame member is movable between a collapsed position and an operating position.

7. The fall arrest assembly according to claim 3 wherein each frame member is of hollow construction.

8. The fall arrest assembly according to claim 3 wherein each frame member comprises two elongate elements pivotally connected.

9. The fall arrest assembly according to claim 3 wherein each frame member is telescopic in nature.

10. The fall arrest assembly according to claim 3 wherein each frame member comprises an elongate element wherein the elongate element is adapted to be pivotally connected to the structure such that the frame member can move between positions.

11. The fall arrest assembly according to any one of the preceding claim 1 wherein the control means moves each frame member between positions.

12. The fall arrest assembly according to claim 1 wherein the control means includes hydraulically operated systems, electro-mechanical type systems or mechanical systems.

13. The fall arrest assembly according to claim 8 wherein the control means is in the form of a hydraulic assembly extending between each elongate element of each frame member to assist in moving the frame member between positions.

14. The fall arrest assembly according to claim 13 wherein the hydraulic assembly incorporates one or more hydraulic rams that are either directly connected to each frame member or connected via a series of linkages or the like, so as to provide the range of motion required to move each frame member between positions.

15. The fall arrest assembly according to claim 1 wherein the fall arrest device comprises at least one self retracting lanyard system.

16. The fall arrest assembly according to claim 15 wherein there are two self retracting lanyard systems.

17. The fall arrest assembly according to claim 15 wherein each self retracting lanyard system comprises a retractable cable adapted to be secured to the operator.

18. The fall arrest assembly according to claim 15 wherein the fall arrest device comprises:
a first receiving means and a second receiving means each adapted to be releasably secured to a structure,
a locking device operably movable between a released condition whereby the first receiving means and second receiving means can move independently of each other, and a locked condition whereby each receiving means is locked relative to each other, Page 5
a cable having a portion adapted to receive and support a securing device attached to an operator,
wherein when the apparatus supports a fallen operator the locking device is maintained in a locked condition, locking the first receiving means relative to the second receiving means, preventing the length of the cable between the first receiving means and second receiving means from increasing, therefore preventing the operator from falling any further.

19. The fall arrest assembly according to claim 18 wherein the cable extends from the first receiving means to the frame and then to the second receiving means.

20. The fall arrest assembly according to claim 1 wherein the fall arrest device is secured to the structure.

21. The fall arrest assembly according to claim 20 wherein the fall arrest device is secured at the base of one of the frame members.

22. The fall arrest assembly according to claim 3 wherein each frame member has guide means to guide the cable of each self retracting lanyard system therealong, the guide means comprising a plurality of guides and pulleys.

23. The fall arrest assembly according to claim 1 wherein the fall arrest device is in the form of a beam/trolley type system or static line type system.

24. The fall arrest assembly according to claim 1 wherein the structure is in the form of a flat bed trailer of a prime mover/semitrailer.

25. The fall arrest assembly according to claim 24 wherein each frame member is located on the perimeter of the trailer so that the frame does not encroach into the useable storage space of the trailer, and when in the collapsed condition the frame can be stowed within the allowable height of the vehicle.

26. A fall arrest assembly for arresting the fall of an operator working at an elevated height, the assembly comprising:
a frame which is adapted to be secured to a structure and is moveable between a collapsed condition and an operating condition; and
a fall arrest device to which the operator is to be connected, the fall arrest device being adapted to cooperate with the frame when in the operating condition, whereby the operator connects to the fall arrest device prior to moving to the elevated height;
wherein the fall arrest device locks when the operator falls from the elevated height to prevent the operator falling further, the frame supporting the operator until the operator can be released.

27. A fall arrest assembly for arresting the fall of an operator working at an elevated height, the assembly comprises-comprising:
a frame which is adapted to be secured to a structure and is moveable between a collapsed condition and an operating condition;
a control means to move the frame between conditions; and
a fall arrest device to which the operator is be connected, the fall arrest device being adapted to cooperate with the frame when in the operating condition, whereby the operator connects to the fall arrest device at ground level prior to moving to the elevated height;
wherein the fall arrest device locks when the operator falls from the elevated height to prevent the operator falling further, the frame supporting the operator until the operator can be released.

28. A fall arrest assembly for arresting the fall of an operator working at an elevated height, the operator wearing a harness, the assembly comprising:
a frame which is adapted to be secured to a structure and is moveable between a collapsed condition and an operating condition;
a control means to move the frame between conditions; and
a fall arrest device to which the harness is to be connected, the fall arrest device being adapted to cooperate with the frame when in the operating condition, whereby the harness is connected to the fall arrest device prior to moving to the elevated height;
wherein the fall arrest device locks when the operator falls from the elevated height to prevent the operator falling further, the frame supporting the operator until the operator can be released.

29. (canceled)
